(19) United States
(12) Patent Application Publication
(10) Pub. No.: US 2011/0291016 A1
(43) Pub. Date: Dec. 1, 2011

(54) NOVEL COLLIMATOR AND METHOD FOR FABRICATING THE SAME

(76) Inventors: Scott METZLER, Haddonfield, NJ (US); Richard Freifelder, Melrose Park, PA (US)

(21) Appl. No.: 12/969,085

(22) Filed: Dec. 15, 2010

Related U.S. Application Data
(60) Provisional application No. 61/286,637, filed on Dec. 15, 2009.

(51) Int. Cl. G21K 1/02

(52) U.S. Cl. 250/363.1; 378/147

(57) ABSTRACT

This invention relates to a collimator. Specifically, the invention relates to a collimator comprising alternate layers of a foam and a radiation blocking elements, and methods for fabricating the same.

### CROSS-REFERENCE TO RELATED APPLICATIONS

This application claims priority to U.S. Provisional Patent Application 61/286,637, filed Dec. 15, 2009, which is incorporated by reference herein in its entirety.

### GOVERNMENT INTEREST

The work described herein was supported, in part, by Grant Number R01-EB-6558 of National Institute of Health, United States Department of Health & Human Services. United States government may have certain rights in this application.

### FIELD OF THE INVENTION

The invention relates to a collimator. Specifically, the invention relates to a collimator comprising alternate layers of a foam and a radiation blocking element, and methods for fabricating the same.

### BACKGROUND OF THE INVENTION

Collimators are used in nuclear-medicine (single photon) imaging of patients, with about 15 million clinical studies per year. A radiolabeled pharmaceutical with biochemical properties relevant to the desired clinical evaluation (e.g., cardiac perfusion) is administered. After a short time for the dose to distribute, an imaging study is performed to assess function. When the study involves a single-photon radioisotope, collimation must be used in order to form an image. The reason is that the point of origin and the direction of the photon are not known. By using collimation, the direction of the photon and its line of origin—but not point or origin—are measured. In positron emission tomography (PET) collimation is not needed because two photons are measured in coincidence.

Different types of collimators have different properties, but they all trade in some way the properties of efficiency, spatial resolution, and field of view. Typically, a clinical camera will come with several different sets of collimators that can be exchanged at scan time for the most appropriate trade-off for a given patient and study type. For example, sometimes high resolution scans are used, sacrificing efficiency. For brain scans, a fan-beam collimator is often used, which gives good resolution and efficiency, but has a small field of view that is sufficient for brain but not the torso.

Collimators are fabricated using several different conventional techniques. All of these techniques are expensive. There is no existing technique for accurately making a “beam” collimator inexpensively. The exception is pinhole collimation, which is excluded as non-beam. Generally, it is difficult to develop and test new types of collimation, and vendors are hesitant to explore new design options.

Some types of beam collimators are impossible or nearly impossible to accurately fabricate with existing techniques. For example, short-focal-length cone-beam or fan-beam collimators for brain imaging or other studies cannot be fabricated. Accordingly, there exists a need for improved collimators and methods for fabricating thereof.

### SUMMARY OF THE INVENTION

In one embodiment, the invention provides an apparatus comprising: an assembly of alternate layers of a foam and a radiation blocking elements, wherein said assembly comprises a plurality of holes for collimation. In some embodiments, the apparatus comprises a foam body comprising a plurality of cut slats, each cut slat comprising a layer of said radiation blocking element in order to provide said assembly of alternate layers of said foam and said radiation blocking elements.

In another embodiment, the invention provides an apparatus comprising: a foam body comprising a plurality of cut slats in a first dimension and a plurality of cut slats in a second dimension, each first dimension cut slat intersecting with each second dimension cut slat, each of the cut slats in both dimensions comprising a radiation blocking element inserted therein in order to provide a plurality of holes for collimation.

In another embodiment, the invention provides an imagining device comprising an apparatus comprising: an assembly of alternate layers of a foam and a radiation blocking elements, wherein said assembly comprises a plurality of holes for collimation.

In another embodiment, the invention provides a method of fabricating a collimator comprising: providing a foam body; cutting said foam body into a plurality of slats; bonding a layer of radiation blocking element in each of said plurality of slats in order to provide an assembly of alternate layers of said foam and radiation blocking elements, wherein said assembly comprises a plurality of holes for collimation.

In another embodiment, the invention provides a method of fabricating a collimator comprising: providing a foam body; cutting said foam body into a plurality of slats; bonding a layer of radiation blocking element in each of said plurality of slats in order to provide an assembly of alternate layers of said foam and radiation blocking elements; cross-cutting said foam body; inserting a layer of radiation blocking element between cut-layers resulting from the cross-cut; bonding the inserted layer of radiation blocking element, wherein said assembly comprises a plurality of holes for collimation.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be better understood from a reading of the following detailed description taken in conjunction with the drawings in which like reference designators are used to designate like elements, and in which:

FIG. 1 shows a view of rectangular foam slab cut in one dimension and filled with layers of radiation blocking element (black lines), according to one embodiment of the invention. The alternating layers of foam and radiation blocking element are held together with adhesives.

FIG. 2 shows a view of rectangular foam slab after it has been cross-cut and re-glued, according to one embodiment of the invention. In this particular example, the focal line offset from the center of the detector.

FIG. 3 shows a method for fabricating a collimator, according to one embodiment of the invention.

FIG. 4 shows a model of parallel-hole collimator with 2 mm×2 mm square holes 30 mm tall. Left: A single hole; a gap can be seen that allows photons to pass. Right: Multiple holes.

FIG. 5 shows simulations of gap penetration. The top images show projections of a point source ont a parallel-beam collimator (2 mm×2 mm holes that are 30 mm tall) that has gap penetration in one direction (horizontal). The size of the gap increases from left to right: 0.005 mm, 0.1 mm, 0.2 mm, 0.3 mm, 0.4 mm, 0.5 mm, 1.0 mm. The bottom shows profiles through the simulated projections.

FIG. 6 shows profiles of the gap simulation with a 1.0 mm gap. Left: Profile in the direction without a gap. Right: profile with the gap.

FIG. 7 shows photographs of two prototypes.

FIG. 8 shows experimental projection images (top) and profiles (bottom) for the prototype seen in FIG. 7. The line source was aligned along the gap direction (left) and perpendicular (right); the profiles are ordered as in FIG. 7. The horizontal and vertical line segments indicate where the profiles were taken.

FIG. 9 shows a photograph of 6 layers of 3 mm thick Rohacell foam that have been laminated into an 18 mm-thick rectangular block using spray adhesive. The foam maintained its rigidity.

FIG. 10 shows that one can design each slat to point at a different focal distance (spatially variable focus). In this case, slat i is oriented at focal distance F₁.

FIG. 11 shows a photograph of Tekoa FC3920 computer controlled (CNC) hot-wire foam cutter.

FIG. 12 shows slitting saw on a milling machine cutting Rohacell foam. A nylon backer was used to support the foam during the cut. The foam is raised vertically between cuts. The bed is moved horizontally so that the foam is passed through the cutting head. Larger diameter slitting blades are available.

FIG. 13: Top: Template made from Styrofoam with CNC hot-wire machine for using a circular saw. Bottom: The template is attached to spacer foam (e.g., Rohacell foam). The circular saw is set to the correct angle and the blade is inserted into the template's kerf. The perpendicular fence is adjusted for a straight cut. A special frame (black) may be needed to align the fence perpendicular to the front face of the foam.

FIG. 14 shows that a kerf is made in a foam slab of width w with a blade of thickness k at an angle θ to the foams surface. The width of the cut parallel to the surface is k csc θ. The cut is not yet all the way through the foam for clarity. Bottom: After the cut's completion, lead foil (black line) with thickness t is inserted between the two foam pieces. The thickness of the lead foil parallel to the foam's surface is t csc θ. The width of the foam slab after assembly is w′=w+(t−k) csc θ.

FIG. 15 shows a photograph of 6 layers of 2 mm-thick Rohacell foam interleaved with lead foil (i.e., a 1D collimator). The surface indicated by the arrow has been cut with a bandsaw (regular ¼ blade with teeth). Spray adhesives was used on all surfaces; the foam maintained its rigidity.

FIG. 16 shows a template made from Slyrofoam with CNC hot-wire for using bandsaw to cross-cut 1D collimator. The template has cuts all the way through (vertically) to match the bandsaw's motion. The template can be attached to the spacer foam. The machinist will have a chart for setting the correct angle for each cut. The blade can then be positioned in the template's kerf. The parallel fence will be adjusted and then the cut will go all the way through the spacer foam.

FIG. 17 shows six cross-cut layers before application of lead foil and stacking. The alternating layers of lead and foam are visible.

FIG. 18: Left: After application of lead foil to three of the six pieces. Right: Completed prototype 2D collimator (Note that the far face does not have lead foil making the foam brighter in color.

FIG. 19: Left: Conceptual drawing of standard collimator frame. Lead foils are typically epoxied permanently into place. Right: An adapter is made so that the foil/foam collimators can be temporarily placed in the frame for rotational testing on the Trionix XLT-9 scanner.

FIG. 20 shows that the collimator foils can be made so that they can be mounted in the collimator frame. In this case, the foam extends beyond the collimating area. Holes in the foam allow it to be secured on posts.

FIG. 21: Top: Conceptual view of rectangular foam slab from FIG. 1. Bottom: Sample mock-up printed on a laser printer that could be used to check the spacing of the top-front and bottom-front edges.

FIG. 22 shows that a precision, machinist's rule can be used to verify accuracy of spacing on laser-printed mock-ups. It can also be placed upon the surfaces of the collimator to ensure accurate linearity of the photograph and to correctly set the scale.

FIG. 23 shows a planer x-ray of prototype collimator shown in FIG. 7(right). The lead septa are white (highly attenuating).

FIG. 24 shows that three orthogonal stages (two manual; one robotic) are used to precisely position a point source.

FIG. 25 shows 2D collimator from FIG. 2 constructed using two layers. The top layer in cross-cut in one direction. The bottom layer is cross-cut in the opposite direction. The two layers are designed to have continuous holes across the seam.

FIG. 26 shows ratio of total counts when a gap is present to total counts without a gap for 2 mm×2 mm channels that are 30 mm tall. The source was a square 2 mm×2 mm to average over one hole; it was 100 mm from the collimator. The 2-layer approach reduces gap penetration for larger gaps. Both have small gap penetration when the gap size is 0.2 mm (10% of edge length) or less.

FIG. 27 shows simulations of gap penetration with a 2 layer collimator. The top images show projections of a point source onto a parallel-beam collimator (2 mm×2 mm holes that are 30 mm tall) that has gap penetration in one direction (horizontal). The size of the gap increases from left to right: 0.0 mm, 0.05 mm, 0.1 mm, 0.2 mm, 0.3 mm, 0.4 mm, 0.5 mm, 1.0 mm. The bottom shows profiles through the simulated projections. These images should be compared with those in FIG. 5 for a 1-layer collimator that is otherwise the same.

FIG. 28 shows resolutions of full width at half maximum (FWHM) and at tenth maximum (FWTM) along the gap as a function of gap size. The configuration was the same as that in FIG. 26. The 2-layer approach maintains resolution better than the 1-layer approach, with only small degradation out to gaps of several tenths of a millimeter.

### DETAILED DESCRIPTION OF THE INVENTION

This invention relates, in one embodiment to a collimator comprising alternate layers of a foam and a radiation blocking elements. In another embodiment, the invention relates to methods for fabricating a collimator comprising alternate layers of a foam and a radiation blocking elements.

In one embodiment, provided herein is an apparatus comprising: an assembly of alternate layers of a foam and a radiation blocking elements, wherein said assembly comprises a plurality of holes for collimation. In some embodiments, the apparatus comprises a foam body comprising a plurality of cut slats, each cut slat comprising a layer of said radiation blocking element in order to provide said assembly of alternate layers of said foam and said radiation blocking elements.

In another embodiment, provided herein is an apparatus comprising: a foam body comprising a plurality of cut slats in a first dimension and a plurality of cut slats in a second dimension, each first dimension cut slat intersecting with each second dimension cut slat, each of the cut slats in both dimensions comprising a radiation blocking element inserted therein in order to provide a plurality of holes for collimation.

In another embodiment, provided herein is an imagining device comprising an apparatus comprising: an assembly of alternate layers of a foam and a radiation blocking elements, wherein said assembly comprises a plurality of holes for collimation.

In another embodiment, provided herein is a method of fabricating a collimator comprising: providing a foam body; cutting said foam body into a plurality of slats; bonding a layer of radiation blocking element in each of said plurality of slats in order to provide an assembly of alternate layers of said foam and radiation blocking elements, wherein said assembly comprises a plurality of holes for collimation.

In another embodiment, provided herein is a method of fabricating a collimator comprising: providing a foam body; cutting said foam body into a plurality of slats; bonding a layer of radiation blocking element in each of said plurality of slats in order to provide an assembly of alternate layers of said foam and radiation blocking element; cross-cutting said foam body; inserting a layer of radiation blocking element between cut-layers resulting from the cross-cut; bonding the inserted layer of radiation blocking element, wherein said assembly comprises a plurality of holes for collimation.

Problems that inhibit production of new collimation are (i) the expense of fabricating new tooling for shaping lead foils according to a new design and (ii) the inability to produce collimators outside of a limited range of parameters. When new tooling is required for each collimator configuration, which is typical in the case of lead-foil collimators, the overhead cost for producing one collimator becomes prohibitive, although additional collimators become inexpensive; this makes development of new, experimental collimation difficult. This problem is further exacerbated when all the axial slices are not the same (e.g., cone-beam) since different tooling is needed for each slice. In addition, some collimators are difficult or nearly impossible to fabricate with the standard techniques of foil-shaping and casting when the focal length is short.

If one uses pins to cast a highly converging collimator, the standard pins that are used for clinical collimators are not long enough to span the distance between the photo-etched plates that are used to support and locate the pins. Also, with casting methods the angle and length of the pins may make them susceptible to bending/breaking due to the forces from the lead's contraction. Thus, hole angulation may be compromised. For short focal length foil collimators, the specialized molds that are required are very difficult and expensive to make. There may also be a large variation in the septal thicknesses between the front and back of the hole. The lead foil must be markedly distorted in order to maintain parallel collimation in the axial direction while simultaneously being highly convergent in the transaxial direction. Again, accurate hole angulation may be difficult to achieve.

Embodiments of the invention may circumvent these problems, allowing for the collimator fabrication that (i) are inexpensive and can produce collimators beyond current limits; (ii) maintain accurate hole spacing and alignment, and (iii) mitigate gap penetration.

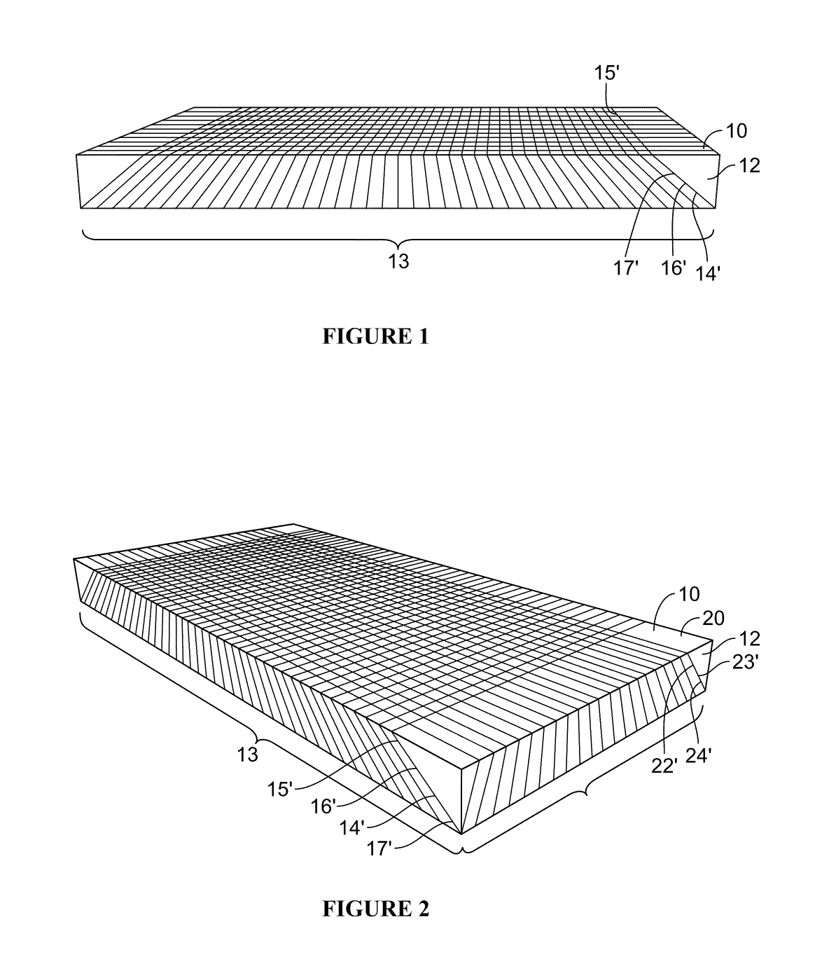

FIG. 1 shows an apparatus 10 for collimation, according to one embodiment of the invention. As shown in FIG. 1, apparatus 10 comprises a foam body 12 having an assembly 13 of alternate layers of a foam 14 and a radiation blocking element 16. Assembly 13 provides a plurality of holes 17 for collimation.

In one embodiment, foam body 12 is cut in one dimension and as a result provides a plurality of cut slats 15. Each cut slat 15 has a layer of radiation blocking element 16 in order to provide assembly 13 having alternate layers of foam 14 and radiation blocking element 16, and as a result provide a plurality of holes 17 for collimation.

In one embodiment, foam body 12 is a rigid foam. In another embodiment, foam body 12 is a non-rigid flexible foam. One can choose the foam body 12 based on its mechanical characteristics, ease of use for a project, or how well it works with bonding agents (e.g., adhesives). A rigid, low-density foam that is mechanically and thermally stable is preferred since it provides the structure necessary to support the layers of radiation blocking element 16 and has low attenuation.

Any suitable foam known to one of skilled in the art may be used as foam body 12. Examples of foam include, but are not limited to, a Rohacell foam, a Styrofoam, a white foam, and a blue foam.

In an exemplary embodiment, radiation blocking element 16 is lead. Other suitable radiation blocking element, known to one of skilled in the art, may also be used. Examples of suitable radiation blocking element include, but are not limited to, lead, tungsten or any suitable lead-free radiation blocking element.

Alternate layers of a foam 14 and a radiation blocking element 16 are bonded together by a bonding agent or mechanism. In some embodiments, bonding agent is an adhesive. Any suitable adhesive, known to one of skilled in the art, may be used as adhesive. Examples of adhesive include, but are not limited to PhotoMount, DisplayMount, Copydex, and their combinations.

The spacing and directions of cutting foam body 12 can be controlled, in accordance with requirements of collimation. In some embodiments, cut slats 15 are equally spaced apart. In other embodiments, cut slats 15 are unequally spaced apart. In some embodiments, cut slats 15 are parallel. In other embodiments, cut slats 15 are not parallel.

Alternate layers of a foam 14 and a radiation blocking element 16 are not limited to any particular number. Any number of layers may be used depending on the need for collimation. In some embodiments, two or more of the alternate layers (14, 16) are parallel to each other. In other embodiments, two or more of the alternate layers are not parallel to each other. Non-parallel alternate layers may provide a plurality of holes 17 for collimation that are capable of providing non-parallel beams, for example, fan-beam, cone-beam, or diverging beam of rays when radiation is passed through assembly 13.

In one embodiment, apparatus 10 comprises a mounting mechanism that enables for mounting apparatus 10 in a frame of an apparatus that requires collimation. In one embodiment, collimator frame is Trionix. In some embodiments, collimator foils are permanently attached by epoxy. In another embodiment, an adopter is used for mounting.

Collimation apparatus 10 may be used in any apparatus that requires collimation, for example, but not limited to, a scanning or imaging apparatus. Examples of a scanning or imaging apparatus include, but are not limited to, a positron emission tomography (PET) scanner and emission computed tomography (SPECT) scanner.

In one embodiment, foam body 12 is cut in two dimensions. In one embodiment, apparatus 10 comprising: a foam body 12 comprising a plurality of cut slats 15 in a first dimension and a plurality of cut slats 23 in a second dimension, each first dimension cut slat intersecting with each second dimension cut slat, each of the cut slats in both dimensions comprising a radiation blocking element 16 inserted therein on order to provide a plurality of holes for collimation 17.

In some embodiments, first dimension cut slats 15 are parallel to each other. In other embodiments, first dimension cut slats 15 are not parallel to each other. In some embodiments, second dimension cut slats 23 are parallel to each other. In other embodiments, second dimension cut slats 23 are not parallel to each other. In one embodiment, one or more of first dimension cut slats 15 are perpendicular to one or more of said second dimension cut slats 23.

Holes 17 may be in any shape suitable for collimation. In one embodiment, one or more holes 17 are in the shape of a rectangle. In another embodiment, one or more holes 17 are in the shape of a square. In some embodiments, one or more holes 17 have identical shape. In other embodiments, one or more holes 17 have a shape different from the other holes. Holes 17 may be in any size suitable for collimation, depending on its application. In some embodiments, one or more holes 17 have identical size. In other embodiments, one or more holes 17 have a size different from the other holes. In one embodiment, holes 17 for collimation are capable of providing fan-beam, cone-beam, or diverging beam of rays when radiation is passed through collimator apparatus 10.

In a particular embodiment, apparatus 10 comprising two-dimensional cut slats (15 and 23) has minimized gap penetration. In one embodiment, the gap size ranges from about 0.01 mm to about 5 mm. In some embodiments, the gap size is 0.01, 0.05, 0.1, 0.2, 0.5, 1, 2, 3, or 5 mm In a preferred embodiment, gap size is less than 2 mm.

In one embodiment, the gap size ranges from about 1% to about 20% of edge length. In some embodiments, the gap size is 1, 2, 3, 5, 10, 15, or 20% of edge length. In a preferred embodiment, gap size is less than 10% of edge length.

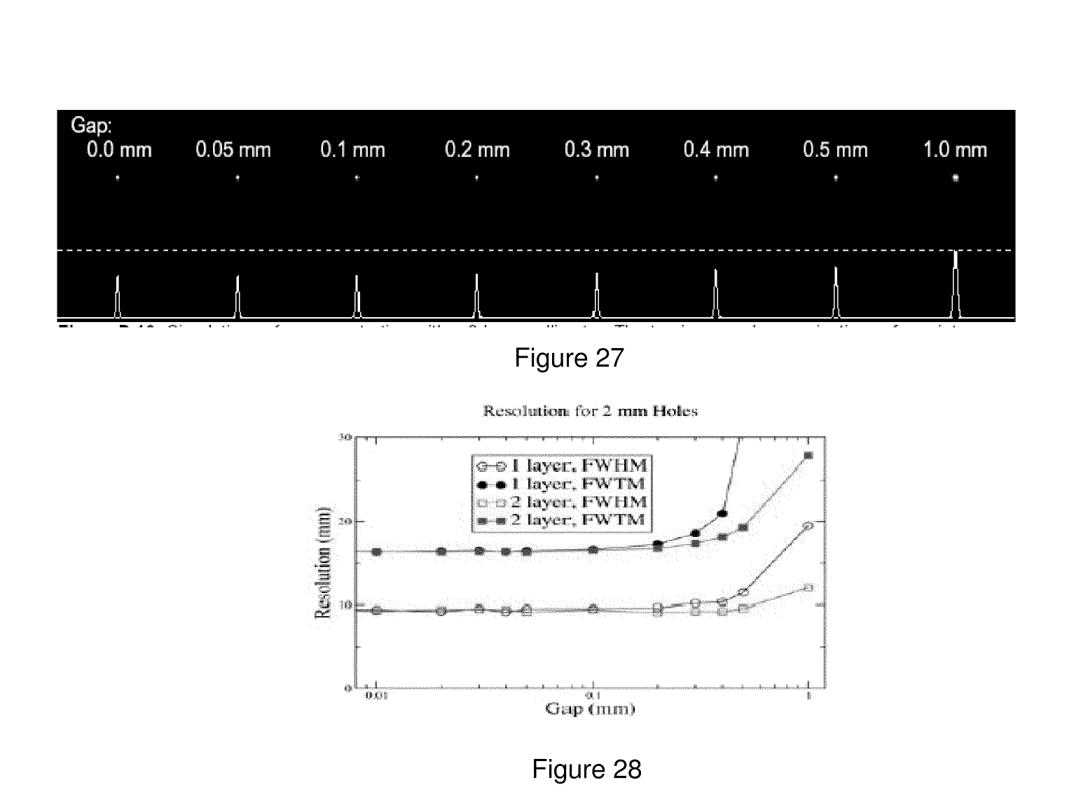

In some embodiments, gap penetration can be reduced by 2-layer approach. For example, collimators can be built using two independent layers (i.e., two 1D collimators that are orthagonal to each other. As shown in FIG. 26, the 2-layer approach reduces gap penetration for larger gaps. Both layers have small gap penetration when the gap size is 0.2 mm (10% of edge length) or less. FIG. 27 shows simulations of gap penetration with a 2 layer collimator. The top images show projections of a point source onto a parallel-beam collimator (2 mm×2 mm holes that are 30 mm tall) that has gap penetration in one direction (horizontal). The size of the gap increases from left to right: 0.0 mm, 0.05 mm, 0.1 mm, 0.2 mm, 0.3 mm, 0.4 mm, 0.5 mm, 1.0 mm. The bottom shows profiles through the simulated projections.

In other embodiments, gap penetration can be reduced by chemical treatment, for example, by treating a chemical that can erode or dissolve foam. Such chemical is known to one of skilled in the art.

In one embodiment, gap penetration can be reduced by a cross-grain collimator. For example, a collimator can be constructed in two layers, where the cross-cuts are perpendicular to each other. In this sense, the “grain” of the collimators runs in different orthogonal directions. In some embodiments, in this 2-layer collimator, photons can pass through multiple holes within a layer, but the second layer may not have any gaps to penetrate. This technique would not impose any additional limitations on the focus of the slats. One would just need to fabricate two 2D collimators that are continuous at the interface (i.e., they may be very different 2D collimators). One would need to carefully align these layers when they are joined.

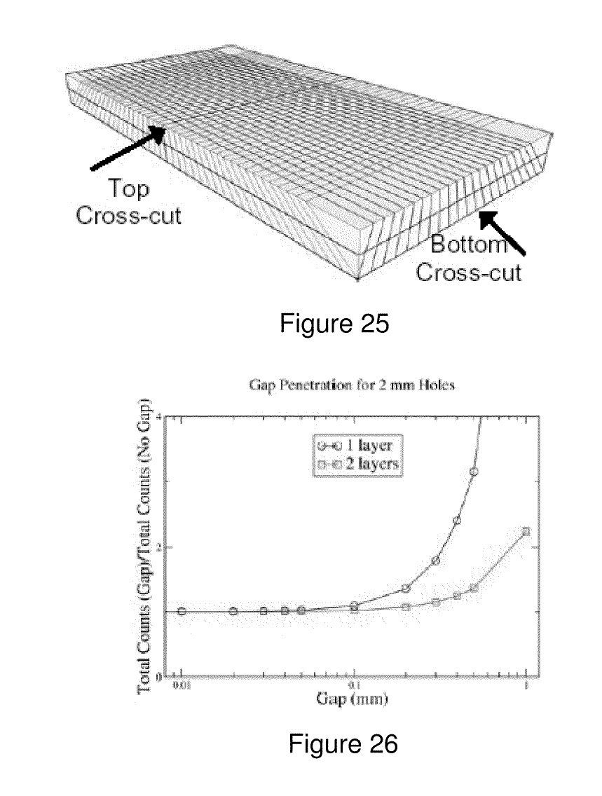

This technique does not increase the overall thickness of the collimator. Instead it splits the 2D collimator into two mating 2D collimators that are each half the thickness. In the simple case of a parallel-beam collimator, this could be accomplished by cutting the completed collimator into two half-thickness pieces. One would be rotated by 90 degrees and then re-attached; thus the gaps do not align. FIG. 25 shows the construction of a converging collimator using this 2-layer technique.

FIG. 2 shows a view of rectangular foam slab after it has been cross-cut and re-glued, according to one embodiment of the invention. In this particular example, the focal line offset from the center of the detector.

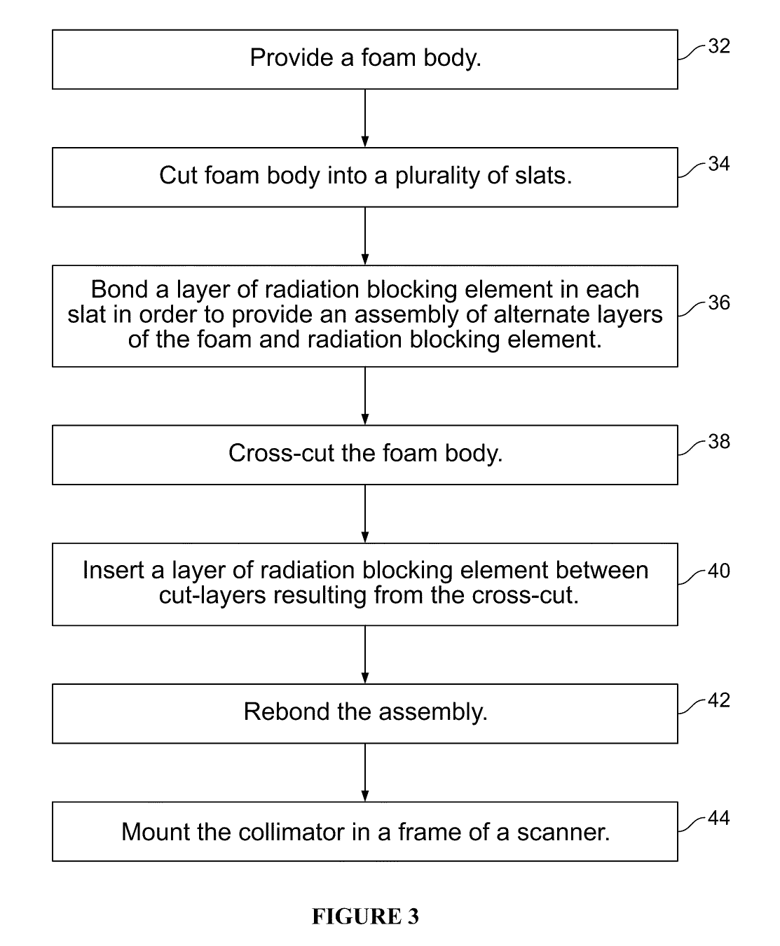

In one embodiment, the invention provides a method for fabricating apparatus 10. As shown in FIG. 3, item 32, foam body 12 may be provided. As shown in FIG. 3, item 34 foam body 12 may be cut into a plurality of slats 15. Any cutting technique known to one of skilled in art can be used. In one embodiment, hot-wire machining technique is used. In another embodiment, traditional machining technique is used. A knife blade that does not have teeth may produce a very clean cut. Blades such as, for example, scalloped or diamond-tipped blades may also be used. In another embodiment, laser machining technique is used.

As shown in FIG. 3, item 36, a layer of radiation blocking element 16 may be bonded in each slat 15 in order to provide assembly 13 of alternate layers of foam 14 and a radiation blocking element 16. As shown in FIG. 3, item 38, foam body 12 may be cross cut using a cutting technique described herein or known to one of skilled in art. As shown in FIG. 3, item 40, a layer of a radiation blocking element 16 may be inserted between cut-layers resulting from the cross cut. As shown in FIG. 3, item 42, assembly 13 may be rebounded by a bonding agent or mechanism described herein or known to one of skilled in the art.

In some embodiments, apparatus 10 may be evaluated using a technique known to one of skilled in the art. Examples of suitable evaluation technique include, but are not limited to, printed mockups, digital photography, X-rays, and acquiring point source data, described in Examples herein. In some embodiments, gap penetration may be evaluated by phantom test or acquiring point source or uniform flood source data, described in Examples herein.

As shown in FIG. 3, item 44, collimator apparatus 10 may be mounted in a frame of a scanner described herein or known to one of skilled in the art.

The following examples are presented in order to more fully illustrate the preferred embodiments of the invention. They should in no way be construed, however, as limiting the broad scope of the invention.

### EXAMPLES

### Example 1

### Experiments

### Monte Carlo Simulation

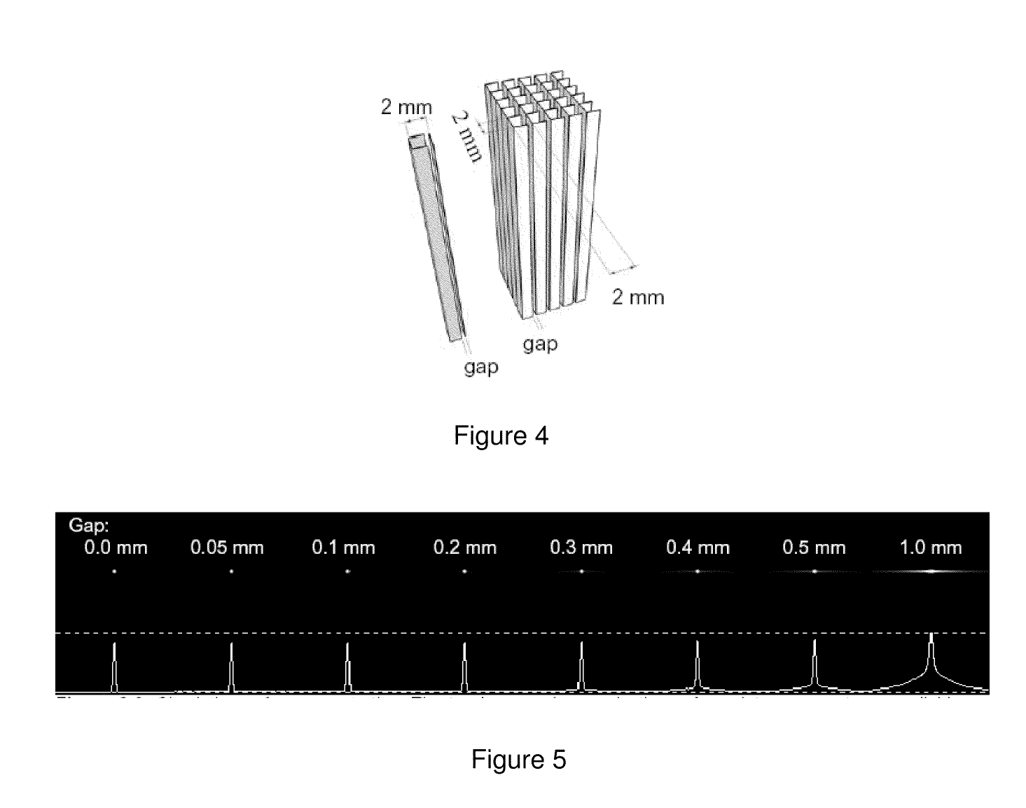

The inventors wrote a Monte Carlo simulation of gap penetration with different magnitudes of gap penetration. In this simulation, 30 mm-tall square holes with septa 2 mm apart were modeled (FIG. 4); the septa were mathematical planes. In one direction, there was no gap (i.e., no missing portion of the septa).

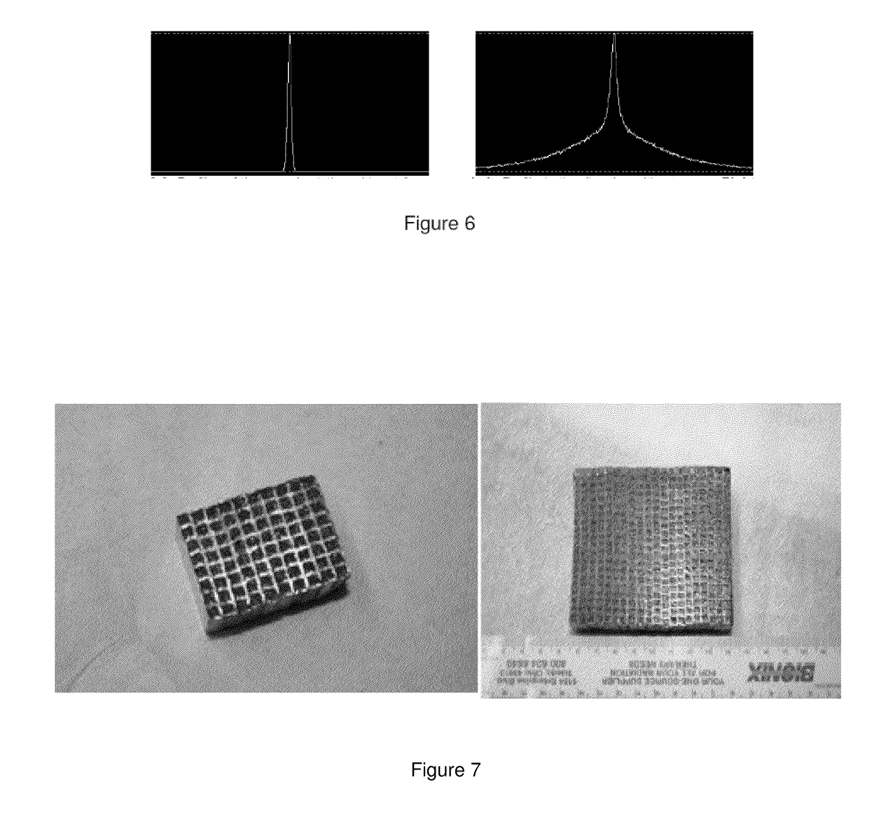

In the other direction, the gap size was varied. Any photon intersecting the plane was absorbed unless it went through the gap. FIG. 5 shows the resulting projections and profiles for different gap sizes. FIG. 6 shows profiles of the 1.0 mm gap in the directions with and without the gap.

### Experimental Prototype Results

Inventors constructed prototype 2D collimators, two of which are shown in FIG. 7. A tc-99m line source was used to test the prototype seen in FIG. 7 (right). The prototype collimator was placed on a Trionix XLT-9 gamma camera.

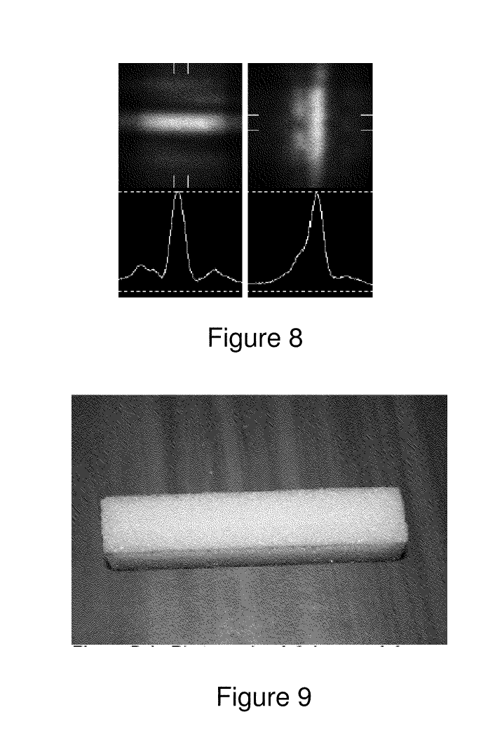

The line source was taken in two orientations: with and against the potential gap with the source a few millimeters above the collimator. The results are shown in FIG. 8. The line is visible in both projections. For 3 mm channels, as in the prototype, and an intrinsic resolution of 3.5 mm, a full width may be at half maximum (FWHM) resolution of 4.6 mm. Inventors measured 4.9 mm (FIG. 8(left)) and 6.4 mm (FIG. 8(right)). This indicates some gap penetration in this prototype.

These data show that measuring the resolution of the profile with the gap compared with that without the gap provides a sensitive tool to assess gap penetration since one direction can serve as a control. These data also show that gap penetration is small if the gap can be limited to a couple tenths of a millimeter. Lastly, the experimental results show that one can construct collimators using this method to limit gap penetration.

### Example 2

### Methods

The first step is to fabricate collimation in only one dimension using lead foil as absorbing slats and using rigid foam to separate the slats and orient them (FIG. 1). Then the layers can be cross cut and lead can be inserted in slats using adhesives to create a block of foam with accurately oriented and positioned holes (FIG. 2).

A Trionix XLT-9 scanner can be used for testing. The techniques in this project can be generally applicable to any type of SPECT scanner.

A method can be developed for fabricating collimators that are more flexible than current methods because new tooling and masks do not need to be developed for each collimator. In addition to making collimators that are hard to make now, especially collimation with axial convergence, this technique will be inexpensive enough to allow special designs for research to be built and experimentally tested.

The spacer pieces, needed for 1D collimation, are cut on an easily programmed machine or as linear cuts in a machine shop. The lead in this method is cut to make the 2D collimator, but it is not otherwise distorted as in when it is pressed into molds. That is, it has a uniform septal thickness even for highly converging collimators. Since the entire surface area of the lead will be glued to the spacers, it can have mechanical stability.

### Techniques for Fabricating One-Dimensional Collimators

1D collimators as shown in FIG. 1 can be accurately fabricated. The term “1D collimator,” as used herein, refers to a collimator that has slats whose normals are all in the same plane; in FIG. 1 all the lead slats have normals in the plane of the front face of the collimator.

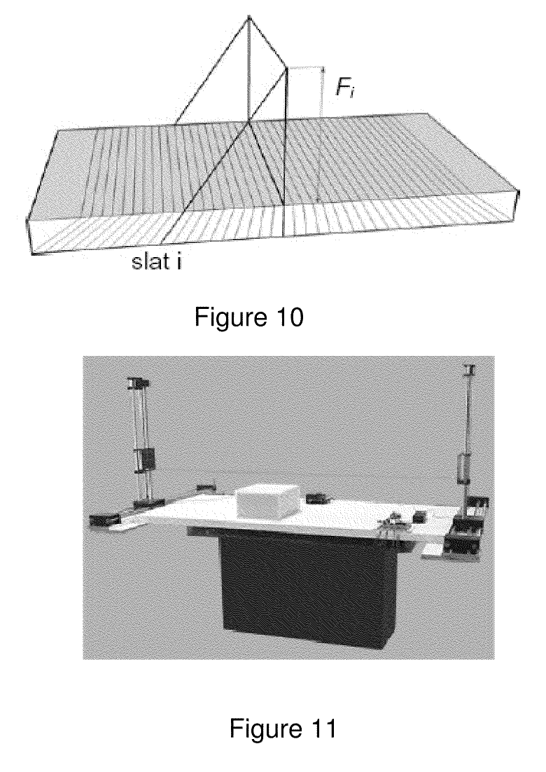

In this study, small samples of foams and adhesives can used to determine if an appropriate combination can be found that is capable of forming a strong bond between the lead and foam without deteriorating the mechanical properties of the foam. One can manually cut these pieces in these early tests, looking at how rigid the foam is, how well the adhesive works, and the properties of the lead foil-foam slab after adhesive has been applied. Inventors have found, for example, that Rohacell sheets may be laminated into a thicker slab using spray adhesives while retaining its mechanical rigidity (FIG. 9). On the other hand, using rubber cement causes the foam to loose its rigidity. After deciding on a foam and machining technique one can fabricate parallel slats (i.e., infinite focal length), methods for fabrication can be developed and several different designs, including non-parallel slats, can be constructed to understand the limits of the process, such as hole size, hole height, and minimum focal lengths. FIG. 10 shows how each slat can be individually oriented with this fabrication technique. If the focal lengths of all slats are equal, the collimator is a fan-beam; if they are all infinite, it is parallel-beam.

### Choice of Foam and Adhesives

One can choose the foam slab based on its mechanical characteristics, ease of use, and how well it works with adhesives. A rigid, low-density foam that is mechanically and thermally stable is preferred since it would provide the structure necessary to support the lead slats, yet it would have low attenuation. From this point of view, Rohacell foam is preferred. It is very rigid and has a low density. It is often used structurally (e.g., commercial airplanes) and also in models. This foam was used on slit-slat collimation, where the lead slats were held evenly spaced and flat using Rohacell foam.

Different foams may be cut using different techniques. In choosing the best foam, one can consider how well it can be shaped to make the appropriate fillers between slats.

Different adhesives can be used with different foams. One can consider the appropriate combinations of foam and adhesive so as to not impede the mechanical properties of the foam. Some adhesives used with foam are Photo Mount (3M), Display Mount (3M), Super 77 (3M), and Copydex. For our prototype testing we used Super 77. One can also use 3M high-tack transfer tape, which can be applied as a film with uniform thickness.

One can also use Rohacell IG-31 foam, which has a density of 31 kg/m³ (mg/cm³) and a linear attenuation coefficient measured to be about 0.005 cm⁻¹ at 140 keV (dry air at sea level has attenuation 0.002 cm⁻¹). Rohacell foam is very rigid. It comes in sheets up to about 90 mm in thickness, but thinner sheets are more commonly available. If necessary, one can laminate sheets to the appropriate thickness (e.g., 3 mm-thick sheets—FIG. 9). Rohacell foam also comes in other densities (e.g., 51, 71, and 110 kg/m³) that may be preferable, despite higher attenuation, because their increased rigidity may improve machining during the second set of cuts, which are needed for the 2D collimator. A draw-back of Rohacell is that it needs to be machined, as opposed to using hot-wire techniques. Consequently, if one can find a rigid foam that has the required mechanical properties, works well with adhesives, and can be machined with hot-wire techniques, one can switch to that alternative foam. For example, one can use Styrofoam, such as white foam and blue foam, if it works well.

### Cutting Foam

The choice of cutting technique will depend on the type of foam used. One of the ways to cut the foam for producing 1D collimators is the use of hot-wire machines, which can be computer controlled. FIG. 11 shows an example hotwire machine that is computer controlled. One can use sacrificial foam underneath so that the wire may be passed cleanly through the spacer foam without overheating at the ends. This will allow to cut along any plane so that each slat can be arbitrarily aligned.

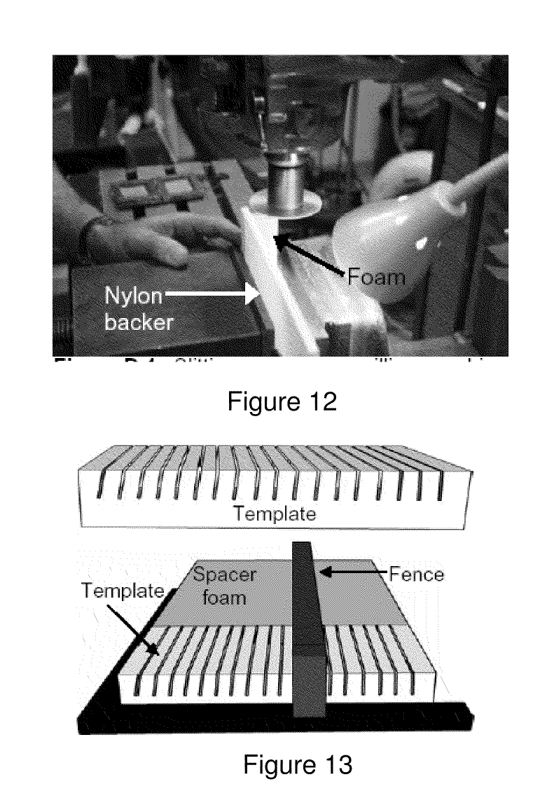

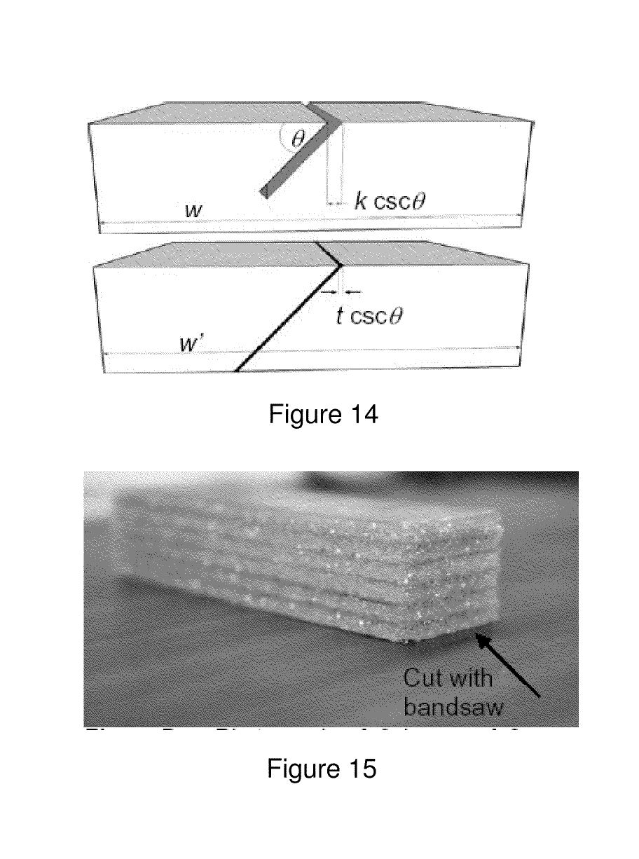

A second option for cutting the foam for 1D spacers is to use traditional machining techniques. One can work with local machine shop for developing an appropriate technique. One possibility is to cut the foam using a slitting saw attachment on a milling machine. This technique was used to cut 2 mm-thick foam from laminated foam with thickness of 18 mm (FIG. 9). The machine very accurately raised the foam. The foam was then pushed through the slitting blade (FIG. 12). One can also consider using a hand-held circular saw with a perpendicular fence (FIG. 13). When used with a fence, the circular saw can make very precise cuts. In addition, the blade angle and depth are easily adjusted. To guide this adjustment, one can use positioning templates that was made using the CNC hotwire machine. The template can then be attached to the spacer foam. The circular saw can then be adjusted for each cut by placing the blade in the template slot while the angle and depth are adjusted. Sacrificial material under the foam may allow to make clean cuts all the way through the foam. Lastly, one can consider using a bandsaw to make these cuts. In both the hot-wire and machining techniques, the slot cut may have a larger kerf, the width of the material removed, than the thickness of the lead foil. When making the cut with these methods, a uniform width of material may be removed; consequently the pieces can be re-assembled without a gap. FIG. 14 shows that the slab can be re-assembled without a gap. After re-assembly is reduced by (k−t)cscθ, where k is the width of the blade, t is the thickness of the lead foil, and θ is the angle of the cut.

FIG. 15 shows a simple 1D collimator the inventors have fabricated using the slitting saw to cut 2 mm-thick foam slices. Lead tape from 3M was applied to each piece of foam. Spray adhesive was then applied to the lead so that the layers could be stacked. As a last step, the edge was straightened with a bandsaw.

### Techniques for Fabricating Two-Dimensional Collimators

The invention provides methods for cross-cutting the one-dimensional collimators and re-assembling the pieces interleaved by lead foil to form a 2D collimator. In a particular embodiment, the invention provides a cross-cutting technique that leaves a clean-cut surface so that gaps between lead surfaces are minimized. The foam may be mounted onto a collimator frame so that it can be rotated for tomography.

### Cross-Cutting Foam

Hot-wire technique, which is a technique for fabricating the 1D collimator, is applicable to cross-cutting because of the presence of the lead foil. However, it is possible that a suitable foam can be found and a suitable temperature and cut-rate can be determined so that the hot-wire technique may be used. One can explore this possibility since the hot wire may act much like a soldering iron, cutting through the lead and drawing it along the foam surface; this may be beneficial since it may reduce gaps between lead surfaces.

One can also use laser machining. One possibility with laser cutting is that more foam may be removed than lead because of the heating process. This may actually turn out to be beneficial since light pressure can than be applied when re-assembling the pieces so that the lead foil is brought into tight contact with adjacent surfaces.

A traditional machining technique may also be used on a 1D collimator made with Rohacell foam. In particular, one can bandsaw the foam to execute the cross-cut. Inventors have attempted this with a small sample and have achieved reasonable results (FIG. 15). Better results may be achieved with different types of bandsaw blades. For example, a “knife” blade that does not have teeth may produce a very clean cut. Other options include scalloped and diamond-tipped blades.

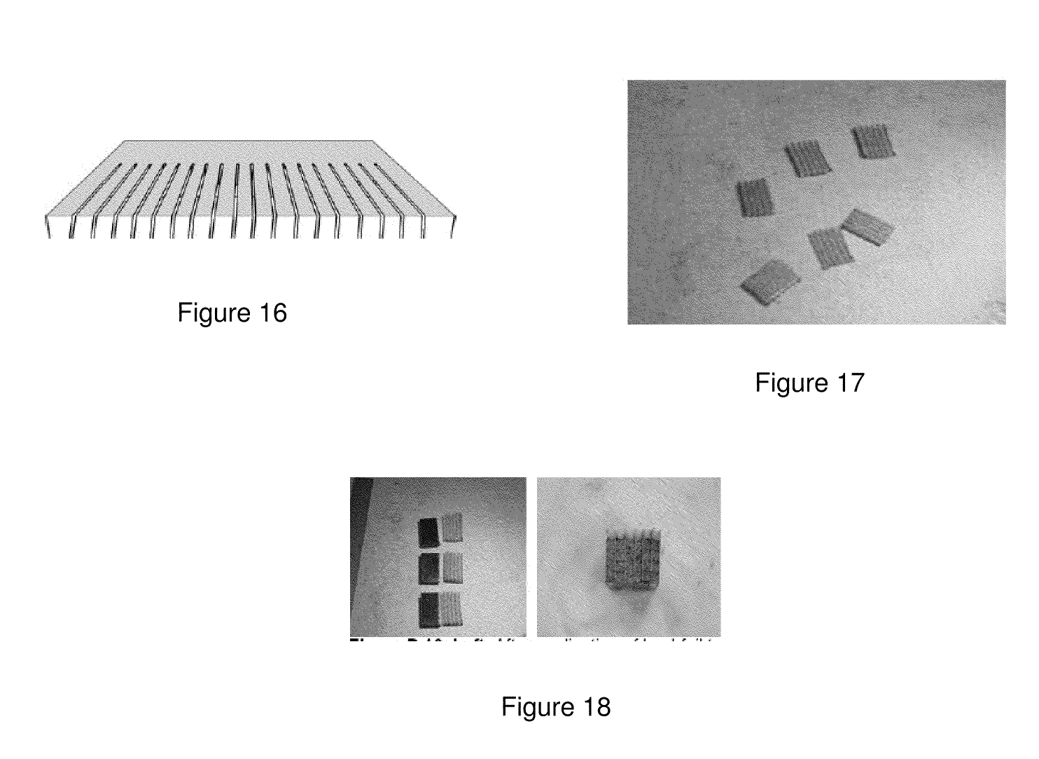

To produce accurate alignments, one can use the CNC hot-wire system with Styrofoam to make a template that yields both the correct angle and spacing (FIG. 16). The template can then be attached to the spacer foam. One can give the machinist an accompanying tilt chart that will show the correct tilt angle for the platform for each cut. When the tilt has been set, the foam is aligned so that the blade starts in the Styrofoam kerf. The 1D collimator is then pushed through along a straight line.

FIG. 17 shows several slices that have been cross-cut with a bandsaw in the cyclotron's machine shop. The alternating layers of lead foil and foam are visible. FIG. 18(left) shows the same slices, but three have lead foil applied on one surface. FIG. 18(right) shows the re-assembled prototype. Two of the later prototypes using the same techniques were also shown in the data (FIG. 7).

### Mounting Foam Collimator in Collimator Frame

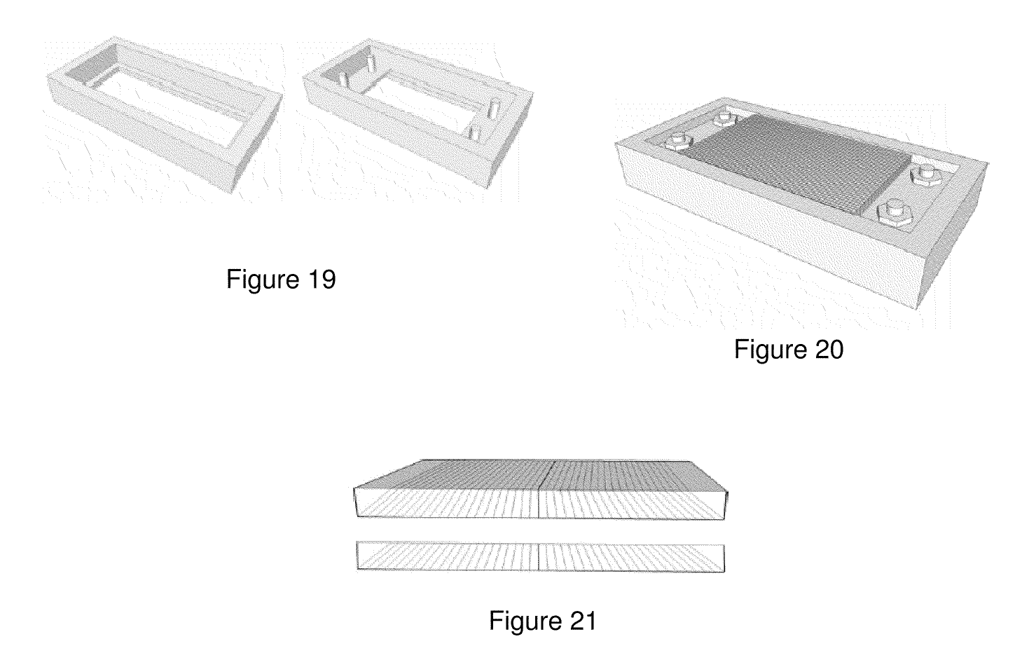

One can use a collimator frame Trionix. The frame is much like a picture frame: there is a hollowed section with a lip that the collimator foils set in (FIG. 19 (left)). Typically, collimator foils are permanently attached with epoxy. Instead, one can use an adapter that will allow to interchange foils (FIG. 19 (right)). One can also design the foam so that it will extend outside the foil/collimating area. One can use large plates to distribute pressure to hold the foam securely in the adapter (FIG. 20). For some routine testing, one can rotate the collimator by 90 degrees to reverse the axial and transverse directions; for these tests, one may need to use smaller collimators and a second adapter. One can have the machine shop fabricate an aluminum cover to protect the collimator when in use.

### Example 3

### Evaluating 1D and 2D Collimators

A simple reconstruction implementations, when necessary, can be used for evaluating if there is substantial gap penetration. One can use parallel-beam (1D and 2D), fan-beam (1D and 2D), cone-beam (2D), and spatially variable collimators (1D and 2D) in these evaluations. The evaluation of 2D collimators with axial convergence, especially with short focal lengths, can be performed because traditional fabrication techniques do not work well in these cases.

### Evaluating Accuracy of Foil Spacing and Orientation

One can evaluate the accuracy of foil spacing and orientation for both 1D and 2D collimators. Four methods are described below. A potential problem with the first two (printed mock-ups and digital photography) is that the edges of the foils may be distorted due to machining even if most of each foil slat is not distorted. If only the very edge is disturbed, it will have little impact on the collimator. To more accurately assess the spacing in this scenario, one may use thicker foils, perhaps made of aluminum, to mitigate distortion; these collimators would then be evaluated only using the first two methods, not the x-ray or point-source methods. The point-source method may give an accurate measure of sensitivity even in the presence of small distortions at the collimator surface.

### Printed Mock-Ups

One can print mock-ups of the intended slat positions on each surface on a laser printer (FIG. 21). For the 1D collimators, mock-ups of four surfaces can be used: top, bottom, front, and back; the two sides do not have any visible slats. For the 2D collimators, mock-ups of all six surfaces can be used. The printed mock-ups can simply be a series of short line segments. For short distances (e.g., top to bottom) one can print the entire line, but for longer distances, one can print only the position at the edge. One can then hold the mock-up on an adjacent surface for comparison. One can also check the positions at both ends of each surface. In total, one can check the alignment at four edges for 1D collimation (i.e., top-front, top-back, bottom-front, and bottom-back) and 8 edges for 2D collimation. One can check the accuracy of the lines on the printed-mock-up using a precision, machinist's rule (FIG. 14).

### Digital Photography

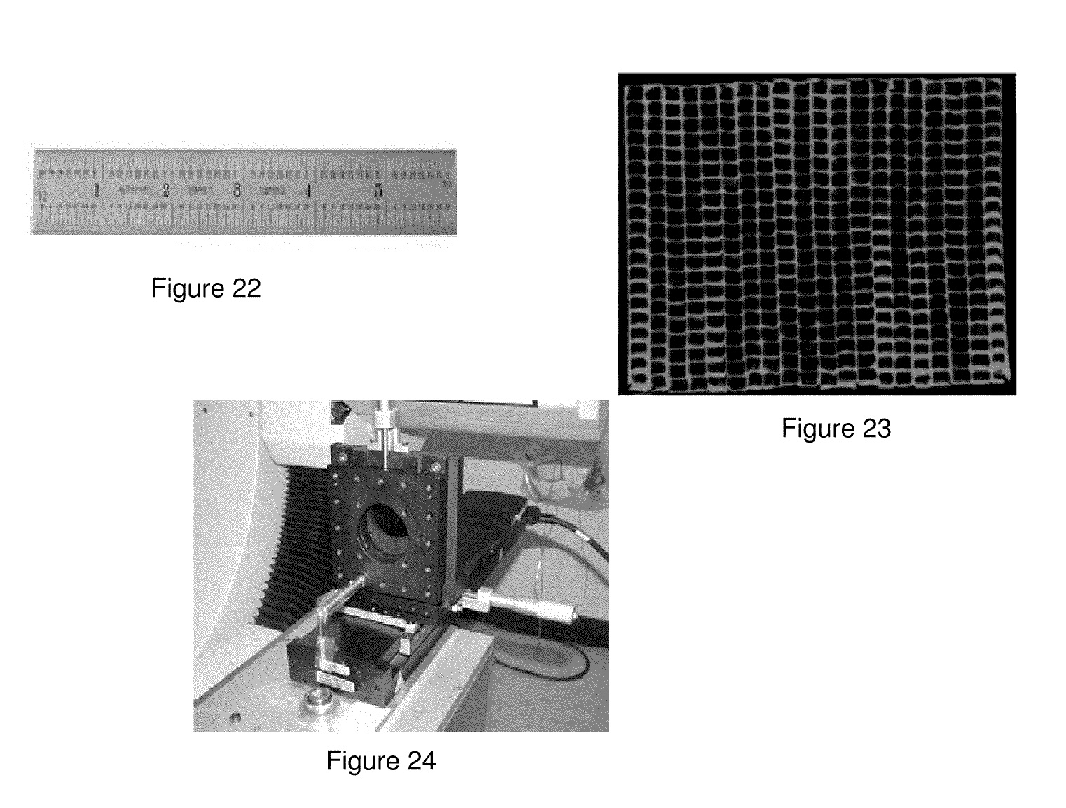

One can use digital photographs of the surfaces of the collimator to measure the accuracy of the slats' spacing and orientation. For the 1D collimators, photographs of four surfaces can be used. For the 2D collimators, photographs of all six surfaces can be used. Multiple photographs of each surface can be taken with the intent of having each portion of each surface in the central field of view of the camera for one photograph in order to minimize distortions. In addition, the digital photographs can be taken with a precision, machinist's rule (FIG. 22), which may set the scale and be used to avoid any non-linearities in the photographs.

### X-Rays

One can consider using planer x-rays when appropriate. For example, if the sample collimator is small or converging. It may also be possible to take a series of x-rays and to stitch them together in order to avoid beam-divergence problems. FIG. 23 shows an example x-ray of the prototype seen in FIG. 7(right).

### Point-Source

One can acquire point-source data at many positions throughout the field of view of each collimator to determine if the slats are accurately spaced and oriented. One can compare the number of expected and observed counts as a function of position; the rationale is that the number of counts is directly related (approximately proportional) to the spacing between slats. One can use simple analytic models for expected counts and can validate these models using Geant4 simulations. Further, one can use two isotopes (e.g., Tc-99m and TI-201), which have different penetration characteristics, so that one can more accurately extract the geometric spacing.

Acquisitions near the collimator's surface may give the best information about the spacing since only one or a small number of holes can have the source in their field of view during a particular acquisition. Acquisitions further from the collimator's surface may yield the best information about orientation since the slats need to be accurately aligned to view points further from the surface. Consequently, many points may be acquired. One can automate the process using robotic stages that are synchronized with the data-acquisition system. FIG. 24 shows an orthogonal stage setup used for semi-automated acquisitions; one stage is robotic and two are manual.

### Evaluating Gap Penetration

Gap penetration is only relevant for 2D collimation, where the 1D slats have been cross-cut, potentially creating gap-penetration problems. Described below are two methods for assessing gap penetration.

### Point-Source

Gap penetration can be assessed by measuring the resolution profile of each hole or a small number of holes. One can use collimators that have the same axial and transaxial focal lengths (this includes parallel-beam) and hole spacings so that a rotation of the collimator by 90 degrees (i.e., exchanging the transaxial and axial directions) would give the same expected experimental results, if there are no gaps. One can make these collimators square so that this rotation is easily accomplished in the collimator frame; one can mask the unused portions of the rectangular frame with lead.

One can acquire point-source data near the surface of the collimator using automated techniques so that a large number of data points can be acquired. Comparing the profiles in the two collimator positions (i.e., 0 and 90 degrees) for the same point-source position may yield an effective tool for determining the degree of gap penetration.

The key is that gap penetration will occur in only one direction, along the direction of the cross-cut. Consequently, one direction can be used as a control since it is known to have no gap penetration. The results from Monte Carlo simulation of gap penetration were shown in FIG. 4. FIG. 5 showed the resulting projections and profiles for different gap sizes. FIG. 6 showed profiles of the 1.0 mm gap in the directions with and without the gap. Experimental results using this method were shown in FIG. 8.

### Uniform Flood Source

One can use a uniform flood source (i.e., a planer source) to simultaneously acquire counts through all holes. This method may not give gap penetration through a resolution measurement, but through a sensitivity measurement. One can write software that identifies bins with unusually high counts.

Phantom Test with Rotational Acquisition

One can acquire rotation emission data from a uniform cylinder to assess gap penetration for parallel-beam, fan-beam, and spatially variable collimation. This may be a sensitive method because gaps that allow transaxial penetration will appear in reconstructions as hot circular artifacts within an axial slice of the reconstruction since there will be excess photons recorded in the transaxial bins where the penetration occurs. Gaps along the axial direction may appear as hot cylindrical shells (i.e., extending along several axial slices).

The lead foil-foam collimator can be mounted in the collimator frame so that one would know which direction (e.g., axial or transverse) is susceptible to gap penetration. Emission data may be acquired by rotating the collimator about the uniform phantom. In some cases, a second scan may be performed, in which one can rotate the collimator by 90 degrees to reverse the direction susceptible to gap penetration. One can consider sampling completeness in these scans to avoid axial blurring artifacts from incomplete data. Consequently, one can use collimators that yield complete data with a circular orbit (e.g., parallel-beam, fan-beam), when performing reconstructions.

A simple, maximum-likelihood iterative reconstructions may be written to reconstruct the projection data. The purpose of the reconstructions is to find artifacts that indicate gap penetration. The purpose is not to develop a highly advanced and efficient reconstruction specific to each type of collimator. Instead, one may re-use many existing utilities and routines from previous reconstruction programs one has written, including helical pinhole, parallel-beam, fan-beam, slit-slat, and multislit-slat reconstructions.

### Example 4

### Alternative Techniques for Addressing Gap Penetration

### Adjust Cutting Techniques

One can cross-cut with the bandsaw. Inventors have had very good results with cross-cutting lead foil on Rohacell with a bandsaw. One may control positioning and feed rate as well as choosing the most appropriate blade type. A “knife”-type blade without teeth is preferred, but one can use different types (e.g., scalloped and diamond-tipped) to determine which gives the best cut.

If the bandsaw is not successful, one may evaluate the quality that can be obtained with laser machining. One can also consider the use of diamond-wire, which uses small diamonds embedded on the surface of a thin wire to make clean cuts with a pulling action. Inventors have done investigations and have found that the “off-the-shelf” machines have size and/or angle restrictions that make them unusable and a custom machine is prohibitively expensive.

One can also consider changing materials. If the cross-cutting problems are due to poor support from the foam, one can consider denser foams. These denser foams may increase attenuation (the densest Rohacell would still have low attenuation of about 0.018 cm⁻¹), but may turn out to be necessary. One can also consider increasing the foil thickness (samples in this proposal use lead with thickness of about 0.005″=0.12 mm). In addition, one can consider the use of materials other than lead. For example, tantalum foil is very dense.

### Chemical Treatment

One can consider the use of chemical treatment of the foam to reduce gaps. Solvents that slightly erode/dissolve the foam may be considered. Small quantities can be applied just before re-assemble. The idea is that by removing a small amount of foam, the lead edges will slightly protrude. These edges will then make better contact with the adjacent lead surface.

### Use “Cross-Grain” Collimators

The real problem of gap penetration is not that photons are mis-recorded in an adjacent hole, but far away because some photons aligned with a surface may pass through many gaps. Therefore, one may construct collimators in two layers, where the cross-cuts are perpendicular to each other. In this sense, the “grain” of the collimators runs in different orthogonal directions. It would be possible in this 2-layer collimator for photons to pass through multiple holes within a layer, but the second layer would not have any gaps to penetrate. This technique would not impose any additional limitations on the focus of the slats. One would just need to fabricate two 2D collimators that are continuous at the interface (i.e., they may be very different 2D collimators). One would need to carefully align these layers when they are joined.

This technique does not increase the overall thickness of the collimator. Instead it splits the 2D collimator into two mating 2D collimators that are each half the thickness. In the simple case of a parallel-beam collimator, this could be accomplished by cutting the completed collimator into two half-thickness pieces. One would be rotated by 90 degrees and then re-attached; thus the gaps do not align. FIG. 25 shows the construction of a converging collimator using this 2-layer technique.

FIG. 26 shows simulated total sensitivity results for 30 mm-tall channels that are 2 mm×2 mm in cross-section. The “1-layer” results are for a collimator made as described in earlier sections. The “2-layer” results have the gaps of two different layers run in orthogonal directions (as in FIG. 25). Two important things stand out in this figure: (i) the 2-layer approach substantially reduces photons through the gaps, even for fairly large gaps; and (ii) if the gaps can be kept to ˜0.2 mm or less, for this case, the effect of gap penetration is small for both techniques.

FIG. 27 shows profiles through the 2-layer collimator. These can be compared with those seen in FIG. 5 of the data with the same collimator configuration except that it was 1-layer. These profiles show that the gap penetration is greatly reduced using the 2-layer approach. FIG. 28 shows the full width at half maximum (FWHM) and full width at tenth maximum (FWTM) values as a function of gap size. These numbers confirm that the 2-layer approach greatly mitigates the effect of the gap out to several tenths of a millimeter.

### Independently Layered Collimators

Collimators can be built using two independent layers (i.e., two “1D collimators” that are orthogonal to each other), but this approach may have less resolution since the total thickness of the collimator would be larger, which can reduce resolution.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

1. An apparatus comprising: an assembly of alternate layers of a foam and a radiation blocking elements, wherein said assembly comprises a plurality of holes for collimation.

2. The apparatus of claim 1, further comprising a foam body comprising a plurality of cut slats, each cut slat comprising a layer of said radiation blocking element in order to provide said assembly of alternate layers of said foam and said radiation blocking elements.

3. The apparatus of claim 1, wherein said apparatus is a collimator.

4. The apparatus of claim 1, wherein said foam is a rigid foam.

5. The apparatus of claim 1, wherein said foam is a non-rigid flexible foam.

6. The apparatus of claim 1, wherein said foam is a Rohacell foam.

7. The apparatus of claim 1, wherein said foam is a Styrofoam, a white foam, or a blue foam.

8. The apparatus of claim 1, wherein said radiation blocking element is lead.

9. The apparatus of claim 1, wherein said radiation blocking element is tungsten or other lead-free radiation blocking element.

10. The apparatus of claim 1, wherein said foam and radiation blocking element are bonded together by a bonding agent or mechanism.

11. The apparatus of claim 10, wherein boding agent is an adhesive.

12. The apparatus of claim 11, wherein said adhesive is PhotoMount, DisplayMount, Copydex, or a combination thereof.

13. The apparatus of claim 1, wherein two or more of said alternate layers are parallel to each other.

14. (canceled)

15. The apparatus of claim 1, wherein said plurality of holes for collimation are capable of providing fan-beam, cone-beam, or diverging beam of rays when radiation is passed through said assembly.

16. The apparatus of claim 1, further comprising a mounting mechanism to mount said apparatus in a frame of a scanning apparatus.

17. The apparatus of claim 16, wherein said scanning apparatus is a biomedical imaging device.

18. The apparatus of claim 16, wherein said scanning apparatus is a positron emission tomography (PET) scanner.

19. The apparatus of claim 16, wherein said scanning apparatus is a single photon emission computed tomography (SPECT) scanner.

20. An imagining device comprising the apparatus of claim 1.

21. An apparatus comprising: a foam body comprising a plurality of cut slats in a first dimension and a plurality of cut slats in a second dimension, each first dimension cut slat intersecting with each second dimension cut slat, each of the cut slats in both dimensions comprising a radiation blocking element inserted therein in order to provide a plurality of holes for collimation.

22-67. (canceled)
